(19) United States
(12) Patent Application Publication
(10) Pub. No.: US 2005/0206057 A1
(43) Pub. Date: Sep. 22, 2005

(54) Resin torque rod and method of producing the same

(75) Inventor: Masami Endo, Niwa-gun (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/079,179

(22) Filed: Mar. 15, 2005

(30) Foreign Application Priority Data
Mar. 19, 2004 (JP) 2004-081182

(51) Int. Cl. B60G 1/00

(52) U.S. Cl. 267/292

(57) ABSTRACT

A resin torque rod including: a first and second bushing disposed at both ends of the resin torque rod, each bushing having a resin outer casing and a rigid inner casing and a rubber elastic body interposed between the outer and inner casings, and a resin connecting component for connecting the first and second bushings, the first and second bushings facing each other at right angles. The rubber elastic body in the second bushing is shaped such that at least outer peripheral portions of axial and faces of the rubber elastic body protrude the same as, or beyond axially outwardly from axial end faces of the resin outer casing of the second bushing, respectively, and that the intermediate portion in an axis-perpendicular direction between the inner casing and outer cuing has a substantially solid shape. A method of producing the resin torque rod is also disclosed.

The disclosure of Japanese Patent Application No. 2004-081182 filed on Mar. 19, 2004 including the specification, drawings and abstract is incorporated herein by reference in its entirety.

### BACKGROUND OF THE INVENTION

1. Field of the Invention

The present invention relates to a torque rod that is interposed between the engine and body of a vehicle to control displacement in the engine rolling direction and the longitudinal direction, as well as to damp vibration between the engine and body. More specifically, the invention relates to a resin torque rod in which outer casings of the first and second bushings as well as a connecting component that connects at both ends with those bushings are made of resin.

2. Description of the Related Art

Conventionally, torque rods are mounted between the engine and body of a vehicle. These torque rods have first and second bushings at both ends, each of which has an outer and inner casing, with a rubber elastic body interposed therebetween, and a connecting component for connecting the first and second bushings, so that the torque rods can take up the torque from the engine to control displacement in the engine rolling direction and the longitudinal direction. Such torque rods also damp vibration between the engine and body.

Conventionally used torque rods include the parallel type of torque rod in which the first and second bushings are disposed in the same direction, and the perpendicular type of torque rod in which the first and second bushings arc disposed facing each other at right angles.

Torque rods of the former parallel type have been disclosed, for example, in JP-U-50-3217, JP-B-4-74569, JP-B-5-14806, JP-A-6-109075 and JP-A-7-197927 (hereinafter referred to as Citations 1, 2, 3, 4, and 5, respectively), and the latter perpendicular type has been disclosed in JP-A-8-233030 and JP-A-2003-206991 (hereinafter referred to as Citations 6 and 7, respectively).

Conventionally known torque rods include resin torque rods in which the outer casing of the first and second bushings and the connecting component that connects them are integrally molded products of resin.

This type of resin torque rod has been disclosed in Patent Citations 1, 2, 3, 5, and 6. Resin torque rods of this type are normally produced in the following manner. Specifically, the rubber elastic body is first vulcanized and bonded with the inner casing, the resulting preliminary rubber elastic body-inner casing assembly is then set up in a mold for resin molding (referred to as resin mold below), and a resin material is then introduced at a certain pressure into the cavity of the resin mold and is solidified, forming a resin molded product, that is, a resin molded product comprising the outer casings of the first and second bushings and the connecting component. At the same time as this, the outer casings and rubber elastic body are fixed, resulting in a unitary torque rod.

In the case of the former parallel type of torque rod in which the first and second bushings are disposed in the same direction, because the first and second bushings face in the same direction, the resin mold can have a simple structure, and the product can be easily taken out of the mold.

The resin mold usually has a structure in which the first and second bushing mold parts are divided along the axes of both bushings, but in the case of parallel type torque rods in which the first and second bushings face in the same direction, the mold divisions of the first and second bushings are in the same direction, so that the resin mold can have a simple structure, and the product can be easily taken out of the mold.

Meanwhile, in the case of the latter perpendicular type of torque rod, that is, torque rods in which the first and second bushings face each other at right angles, the direction in which the first and second bushing mold parts divide are 90 degrees apart, resulting in a complex mold structure.

FIGS. 10A through 12B are illustrate this in detail in an example of a perpendicular type of torque rod. In the figures, 200 is a resin torque rod, 202 is the first bushing comprising the larger bushing, and 204 is the second bushing comprising the smaller bushing. They are disposed facing each other in directions that are 90 degrees apart. Specifically, the first bushing 202 and second bushing 204 are disposed with their axes at right angles to each other. The first bushing 202 and second bushing 204 are disposed apart from each other, and they are joined to each other by a connecting component 206.

As illustrated in FIGS. 10A and 10B, the first bushing 202 comprises a resin outer casing 208, a metal inner casing 210, and a rubber elastic body 212 interposed between to join them. In this case, the rubber elastic body 212 is integrally bonded by vulcanization to the inner casing 210. It is also fixed to the outer casing 208 at the same time that the resin outer casing 208 is formed.

The second bushing 204 similarly comprises a resin outer casing 214, a metal inner casing 216, and a rubber elastic body 218. In the second bushing 204, the rubber elastic body 218 is integrally bonded by vulcanization to the inner casing 216, and is also fixed to the outer casing 214 at the same time that the resin outer casing 214 is formed.

In the torque rod 200, the outer casing 208 of the first bushing 202, the outer casing 214 of the second bushing 204, and the connecting component 206 are in the form of a unitary resin molding. As illustrated in FIG. 11D, the connecting component 206 has an I-shaped cross section, specifically, is I-shaped such that it is open in the direction perpendicular to the axial direction of the first bushing 202.

As shown in FIG. 11B, voids 226 and 228 passing through in the axial direction are formed in the rubber elastic body 212 of the first bushing 202, i.e., the greater bushing. As shown in FIG. 11C, annular recesses 230 and 232 are formed at both axial end surfaces in the rubber elastic body 218 of the second bushing 204, i.e., the smaller bushing. The annular recesses 230 and 232 form an indented shape inward in the axial direction from the axial end surfaces of the outer casing 214.

To manufacture this resin torque rod 200, a unitary vulcanized molding of the inner casing 210 and the rubber elastic body 212 of the first bushing 202, and a unitary vulcanized molding of the inner casing 216 and the rubber elastic body 218 of the second bushing 204 are pre-formed. They are set up in the resin mold 220 illustrated in FIG. 12, a resin material is injected and allowed to solidify in the cavities 222 and 224 of the resin mold 220, that is, the cavities 222 and 224 formed between the resin mold 220 and rubber elastic bodies 212 and 218, and the outer casings 208 and 214 of the first bushing 202 and second bushing 204 are integrally formed at the same time that the connecting component 206 is formed.

234 and 236 in FIG. 12 indicate the mold parts of the resin mold 220 for molding the first bushing 202 and second bushing 204. As illustrated, the direction in which molding part 234 for the first bushing 202 divides is the axial direction of the first bushing 202. Specifically, the direction in which the divided molds 234-1 and 234-2 divide is the axial direction of the first bushing 202. Similarly, the direction in which the mold part 236 divides is the axial direction of the second bushing 204. Specifically, the direction in which the divided molds 236-1 and 236-2 divide is the axial direction of the second bushing 204.

This because the voids 226 and 228 passing through the rubber elastic body 212 in the axial direction are formed in the first bushing 202, and the molding cannot be taken out of the mold unless the direction in which the mold part 234 divides is the axial direction of the first bushing 202. Similarly in the mold part 236, the annular recesses 230 and 232 forming an indented shape inward in the axial direction from the axial end surfaces of the outer casing 214 are formed in the rubber elastic body 218 of the second bushing 204, so that the molded product cannot be taken out of the mold unless the direction in which the mold divides is the axial direction.

However, FIGS. 10 and 11 reveal that the first bushing 202 and second bushing 204 face in directions 90 degrees apart in the torque rod 200, and that the direction in which the mold part 234 for the first bushing 202 and the mold part 236 for the second bushing 204 divide in directions 90 degrees apart. The structure of the resin mold 220 is thus inevitably complicated. The resin mold 220 is thus expensive, and molding operations are complicated, including mold assembly and separation. The complexity of the resin mold 220 structure results in a fewer number of products (resin torque rods) per resin mold 220, which contributes to greater resin torque rod 200 manufacturing costs.

### SUMMARY OF THE INVENTION

It is therefore one object of this invention to provide a resin torque rod capable of simplifying the structure of the resin mold for forming the resin torque rod, permitting a greater number of torque rods to be obtained per resin mold, and reducing torque rod manufacturing costs. It is another object of the invention to provide a method of producing the resin torque rod of the invention.

The above and/or optional objects of this invention may be attained according to at least one of the following modes of the invention. Each of these modes of the invention is numbered like the appended claims and depending from the other mode or modes, where appropriate, to indicate possible combinations of elements or technical features of the invention. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a resin torque rod that comprises: a first and second bushing disposed at both ends of the resin torque rod, each bushing having a resin outer casing and a rigid inner casing and a rubber elastic body interposed between the outer and inner casings, and a resin connecting component for connecting the first and second bushings, the first and second bushings facing each other at right angles, wherein the rubber elastic body in the second bushing is shaped such that the least outer peripheral portions of axial end faces of the rubber elastic body protrude the same as, or beyond axially outwardly from axial end faces of the resin outer casing of the second bushing, respectively, and that the intermediate portion in an axis-perpendicular direction between the inner casing and outer casing has a substantially solid shape, without any recesses open in the axial end faces thereof and extending axially inward from the axial end faces of the outer casing.

The second mode of the invention provides a resin torque rod according to the first mode, wherein the rubber elastic body of the first bushing is provided with voids extending axially inward from the axial end faces of the outer casing in the first bushing.

The third mode of the invention provides a resin torque rod according to the aforementioned first or second mode, wherein the voids in the first bushing pass through the rubber elastic body in the axial direction.

The fourth mode of the invention provides a resin torque rod according to any one of the aforementioned first through third modes, wherein the first bushing has a greater diameter than the second bushing, and the second bushing is smaller than the first bushing.

The fifth mode of the invention provides a resin torque rod according to any one of the aforementioned first through fourth modes, wherein the connecting component comprises a pair of mutually facing side panels that extend in a direction linking the first and second bushings, and a connecting portion connecting the side panels, the pair of side panels and connecting portion having a U- or H-shaped lateral cross section open in a same direction as an axial direction of the first bushing.

The sixth mode of the invention provides a resin torque rod according to the afore mentioned fifth mode, wherein a reinforcing rib extending from a first bushing side to a second bushing side is provided in a space on an inside between the pair of side panels of the connecting component.

A seventh mode of the invention provides a resin torque rod according to any one of the aforementioned first through sixth modes, wherein the rubber elastic body of the second bushing is provided with a shallow annular depression open in the axial end face at an inner peripheral portion thereof.

As noted above, in the resin torque rod of the invention, the shape of the rubber elastic body in the second bushing is such that at least the axial outer surfaces of the outer casing protrude the same as, or slightly beyond in the axial outward direction, the axial end faces of the resin outer casing of the second bushing.

According to the invention, the mold part for the second bushing in the resin mold can divide in the direction perpendicular to the axial direction of the second bushing. That is, the mold part for the first bushing and the mold part for the second bushing in the resin mold both divide in the same direction.

This allows the structure of the resin mold to be simplified, allows the cost of the resin mold to be reduced, allows a greater number of torque rods to be obtained per resin mold, and allows the torque rod manufacturing costs to be reduced.

The invention is more effective when applied to a resin torque rod in which the first bushing has axially extending voids, particularly a resin torque rod in which the voids pass axially through the rubber elastic body (Second or Third Modes).

In the present invention, the first bushing can be the greater bushing with a greater diameter than the second bushing, and the second bushing can be the smaller bushing (fourth Mode).

The dividing direction of the molding part for the connecting component in the resin mold, that is, the molding part for the connecting component that connects the first and second bushings, can be readily aligned with the dividing direction of the molding parts for the first and second bushings by making the shape of the connecting component into a suitable shape, such as a cross-shaped, round, elliptical or diamond-shaped cross section. This will allow the resin mold as a whole to have a dividing structure in the axial directions of the first and second bushings.

The shape of the connecting component in such cases is preferably one having a pair of mutually facing side panels that extend in the direction linking the first and second bushings, and a connecting portion connecting them, where the cross section is U- or H-shaped, being open in the same direction as the axial direction of the second bushing (Fifth Mode).

In this case as well, a reinforcing rib extending from the first bushing side to the second bushing side can be provided in the space on the inside between the pair of side panels in the connecting component (Sixth Mode).

Providing such a reinforcing rib can increase the strength of the connecting component when the connecting component has a U- or H-shaped cross section.

An eight mode of the present invention provides a method of manufacturing a resin torque rod including: a first and second bushing disposed at both ends of the resin torque rod, each bushing having a resin outer casing and a rigid inner casing and a rubber elastic body interposed between the outer and inner casings; and a resin connecting component for connecting the first and second bushings, the first and second bushings facing each other at right angles, wherein the rubber elastic body in the second bushing is shaped such that at least outer peripheral portions of axial end faces of the rubber elastic body protrude the same as, or beyond axially outwardly from axial end faces of the resin outer casing of the second bushing, respectively, and that the intermediate portion in an axis-perpendicular direction between the inner casing and outer casing has a substantially solid shape, without any recesses open in the axial end faces thereof and extending axially inward from the axial end faces of the outer casing, the method comprising the steps of: preparing first and second preliminary assemblies for the first and second bushings, each being formed by molding and bonding the rubber elastic body onto the rigid inner casing; setting up the first and second preliminary assemblies in a mold having a first cavity part with a shape corresponding the outer casing of the first bushing, a second cavity part with a shape corresponding the outer casing of the second busing and a third cavity part with a shape corresponding to the connecting component, such that an axis of the first preliminary assembly extends along with a mold dividing direction, while an axis of the second preliminary assembly extend perpendicular to the mold dividing direction; injecting a resin material into the cavity parts to integrally form the outer casings of the first and second bushings and connecting component with the first and second preliminary assemblies; and dividing the mold into mold parts in the mold dividing direction along with an axial direction of the preliminary assembly of the first bushing to taken out a molded product from the mold.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIGS. 1A and 1B are perspective views of a resin torque rod of construction according to a first embodiment of the invention;

FIGS. 2A and 2B are cross sectional views of the resin torque rod of FIGS. 1A and 1B;

FIGS. 3A and 3B are cross sectional views showing one manufacturing step of the resin torque rod of FIGS. 1A and 1B;

FIGS. 4A and 4B are cross sectional views showing another manufacturing step of the resin torque rod of FIGS. 1A and 1B, successive to that of FIGS. 3A and 3B;

FIGS. 5A and 5B are cross sectional views showing another manufacturing step of the resin torque rod of FIGS. 1A and 1B, successive to that of FIGS. 4A and 4B;

FIG. 6 is a perspective view showing the manufacturing step of FIG. 5;

FIGS. 7A-7C are cross sectional views showing a resin mold for molding the resin torque rod of FIGS. 1A and 1B, wherein a mold opening direction is indicated by arrows;

FIG. 8 is a cross sectional view showing connecting portion used in a resin torque rod of construction according to another embodiment of the invention;

FIG. 9 is a fragmentally enlarged cross sectional view showing a part of a resin torque rod of construction accord to yet another embodiment of the invention, together with a corresponding part of the resin mold;

FIGS. 10A and 10B are perspective views of a conventional resin torque rod;

FIGS. 11A and 11B are a front view and a plane view of the resin torque rod of FIGS. 10A and 10B, respectively, and FIGS. 11C-11E are cross sectional views of principle parts of the resin torque rod; and

FIGS. 12A and 12B are views explaining defects in the conventional resin torque rod.

### DETAILED DESCRIPTION OF PREFERRED EMBODIMENTS

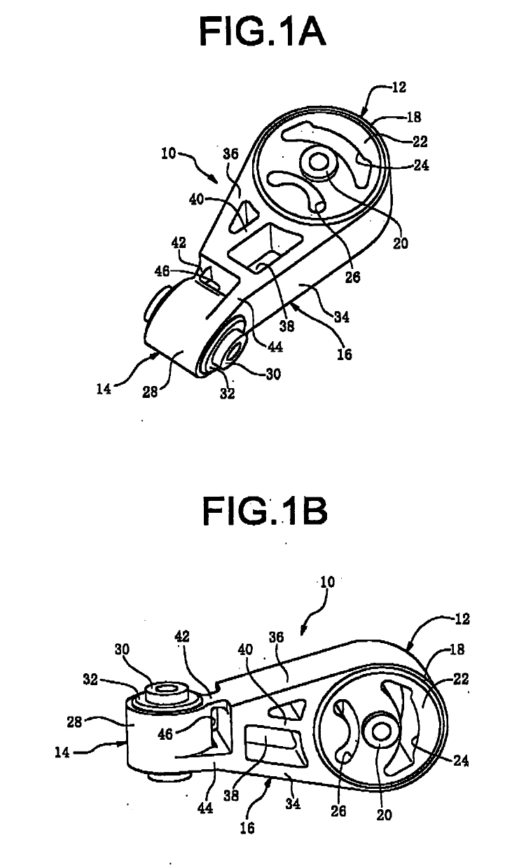

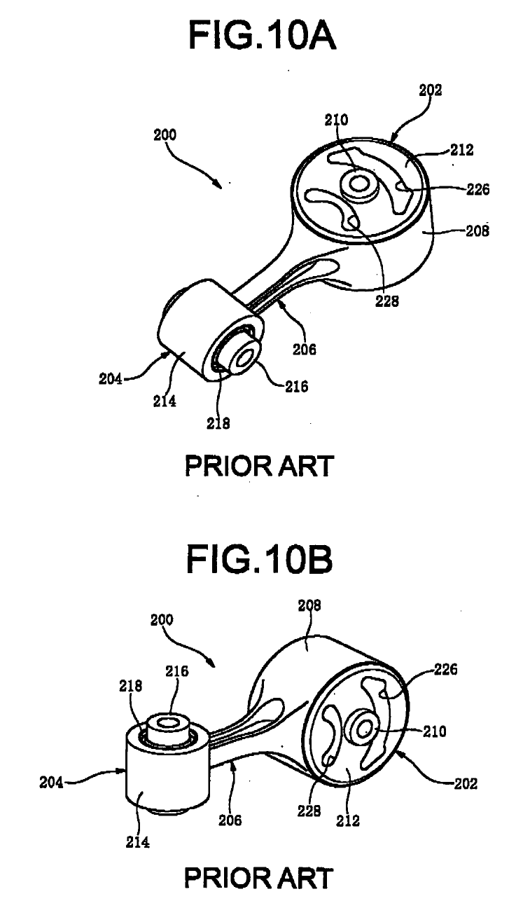

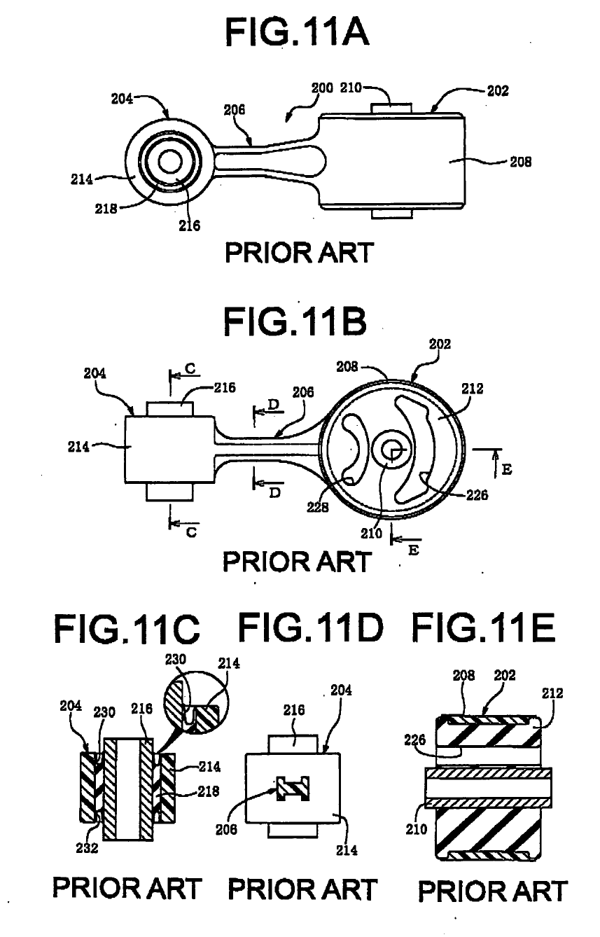

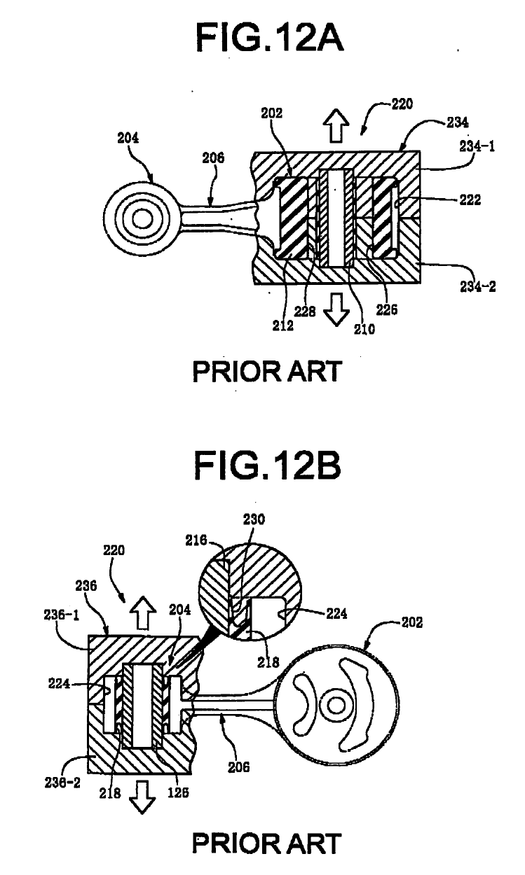

Referring first to FIGS. 1 and 2, 10 is a torque rod (resin torque rod), comprising a first bushing 12 composed of a larger cylindrical bushing at one end, and a second bushing 14 composed of a smaller cylindrical bushing at the other end. These are joined to each other by a resin connecting component 16. The first bushing 12 and second bushing 14 are disposed facing at right angles to each other. Specifically, their axes are disposed facing at right angles.

The second bushing 14 and first bushing 12 of the torque rod 10 are elastically joined to the engine and body sides, respectively, for example, to take up torque from the engine in order to control displacement in the engine rolling direction and displacement in the longitudinal direction. The torque rod 10 also damps vibration between the engine and body sides.

The first bushing 12 comprises a resin outer casing 18 integrally formed with the resin connecting component 16, a metal inner casing 20, and a rubber elastic body 22 interposed between the casings to join them to each other on the inside and outside. The rubber elastic body 22 is integrally bonded by vulcanization to the inner casing 20. It is also fixed to the outer casing 18 at the same time that the resin outer casing 18 is formed. The rubber elastic body 22 is also provided with voids 24 and 26 passing through in the axial direction at circumferential positions opposed to each other in the diametric direction with the inner casing 20 interposed therebetween.

The second bushing 14 comprises a resin outer casing 28 integrally formed with the resin connecting component 16, a metal inner casing 30, and a rubber elastic body 32 interposed between the casings to join them to each other on the inside and outside. In the second bushing 14 as well, the rubber elastic body 32 is integrally bonded by vulcanization to the inner casing 30, and is also fixed to the outer casing 28 at the same time that the resin outer casing 28 is formed.

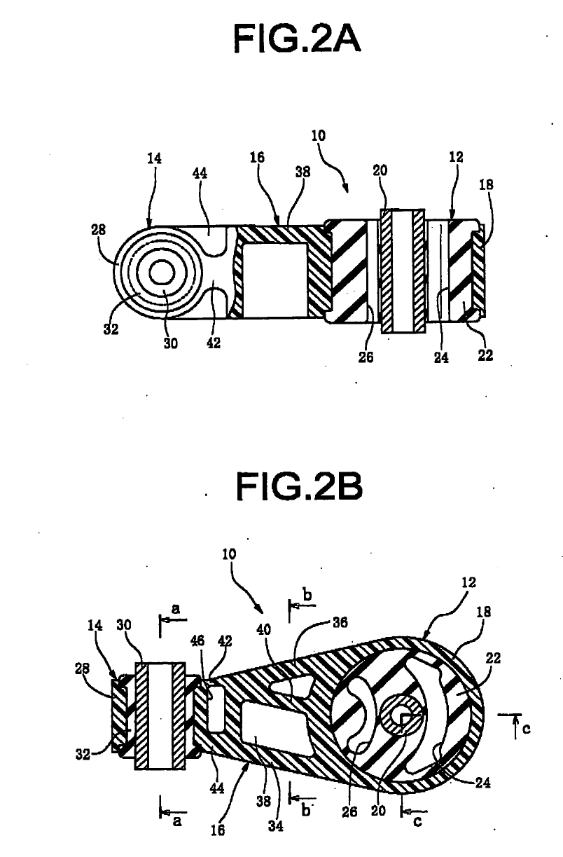

The rubber elastic body 32 has a solid form completely filling the space between the outer casing 28 and inner casing 30 along the fall axial length of the outer casing 28. Specifically, unlike the rubber elastic body 22 of the first bushing 12, it has a solid form without any voids extending in the inward axial direction from the end surfaces of the outer casing 28, in the intermediate region in the axial perpendicular direction between the outer casing 28 and inner casing 30. As Illustrated in FIG. 2B, the entire axial length of the rubber elastic body 32 in the second bushing 14 is longer (axial length of the second bushing 14) than the resin outer casing 28. Both outside surface in the axial direction protrude outwardly beyond the end surfaces in the axial direction of the outer casing 28.

As furthermore illustrated in FIG. 2A, the entire axial length of the rubber elastic body 22 in the first bushing 12 is longer (axial length of the first bushing 12) than the resin outer casing 18. Outer peripheral portions of both axial end faces of the rubber elastic body 22 protrude outwardly beyond the outer casing 18.

The resin connecting component 16 comprises a pair of mutually facing side panels 34 and 36 that extend in the direction linking the first bushing 12 and second bushing 14, and a connector 38 in the form of a connecting panel connecting them to each other. These parts have a U-shaped lateral cross section open in the same direction as the axial direction of the first bushing 12.

The connecting component 16 is also provided with a reinforcing rib 40 that extends at an incline from the first bushing 12 to the second bushing 14 side in the space on the inside of the pair of side panels 34 and 36. The reinforcing rib 40 is in the form of a panel extending parallel to the axial direction of the first big 12.

In this embodiment, the end on the second bushing 14 side of the connecting component 16 is in the form of a first bridge 42 and second bridge 44, and is linked to the second bushing 14 by the first bridge 42 and second bridge 44.

The first bridge 42 and second bridge 44 are located at a position deviating (offset) in the axial direction of the second bushing 14 relative to the central axis of the connecting component 16. That is, the center axis through the axial center of the first bushing 12 and the axial center of the second bushing 14. Specifically, the first bridge 42 and second bridge 44 are located on one and the other sides, respectively, in the axial direction of the second bushing 14 in the connecting component 16. A concave component 46 is formed between the frat bridge 42 and the second bridge 44. The concave component 46 passes through the connecting component 16 in the axial direction of the first bushing 12.

In this embodiment, the wall of the first bridge 42 is thinner than the second bridge 44 in the axial direction of the second bushing 14. The wall of the second bridge 44 is relatively thicker than the first bridge 42. The first bridge 42 and second bridge 44 are in the form of flat panels extending in the axial direction of the first bushing 12.

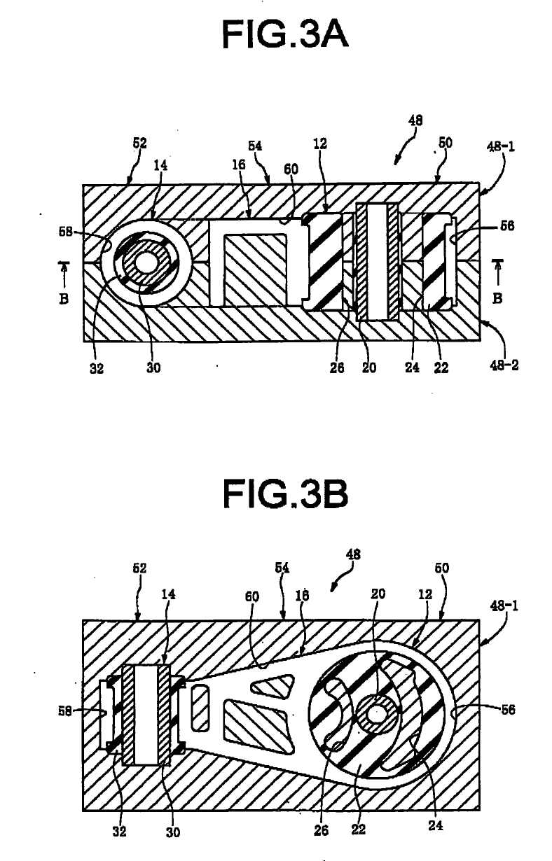

FIG. 3 illustrates the structure of a resin mold (mold for molding resin) for integrally molding the resin molded products of the torque rod 10. That is, the outer casing 18 of the first bushing 12 and the outer casing 28 of the second bushing 14. In FIG. 3, 48 is a resin mold for integrally molding the resin outer casings 18 and 28 and the connecting component 16. 50 is a mold part for the first bushing 12, 52 is a mold part for the second bushing 14, and 54 is a mold part for the connecting component 16.

The mold part 50 has a cavity (a first cavity part) 56 with a shape corresponding to the outer casing 18, and the mold part 52 has a cavity (a second cavity part) 58 with a shape corresponding to the outer casing 28. The mold part 54 has a cavity (a third cavity part) 60 with a shape corresponding to the connecting component 16, which communicates with the cavities 56 and 58.

The resin mold 48 comprises a pair of dividing mold parts 48-1 and 48-2 which divide in the axial direction of the first bushing 12. That is, the resin mold 48 as a whole has a divided mold structure that divides in the axial direction of the first bushing 12.

A specific procedure for producing the torque rod 10 using the resin mold 48 will now be described. In this embodiment, the rubber elastic body 22 of the first bushing 12 is vulcanized and molded, and is simultaneously integrally bonded with the inner casing 20 by being vulcanized. Similarly, the rubber elastic body 32 of the second bushing 14 is vulcanized and molded, and is simultaneously integrally bonded with the inner casing 30 by being vulcanized.

As illustrated in FIG. 3A, the resulting preliminary assembly of the rubber elastic body 22 on the first bushing 12 side and the inner casing 20, and the preliminary assembly of the rubber elastic body 32 on the second bushing 14 side and the inner casing 30, are set up in the resin mold 48, and the cavities formed in the resin mold 48, that is, the cavities 56 and 58 for forming the outer casings 18 and 28 formed between the resin mold 48 and the rubber elastic bodies 22 and 32, as well as the cavity 60 connected to them, are filled with a resin material which is molded into the desired shapes. A resin material may preferably be selected fiber reinforced resins, such as nylon 66 (PA66) containing glass fibers by 50 weight %, for example.

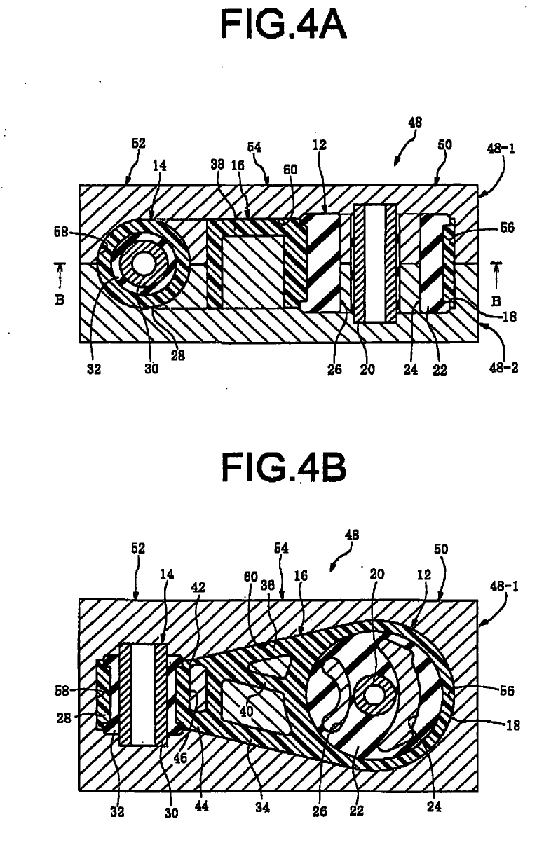

FIG. 4 is an illustration in which a resin material is thus injected into the cavities 56, 58, and 60, and is integrally formed along with the preliminary assembly of the rubber elastic body 22 and the inner casing 20, and the preliminary assembly of the rubber elastic body 32 and the inner casing 30. The resulting molded product, that is, the torque rod 10, is easily taken out of the resin mold 48 by splitting the resin mold 48, that is, the divided molds 48-I and 48-2, in the axial direction of the first bushing 12.

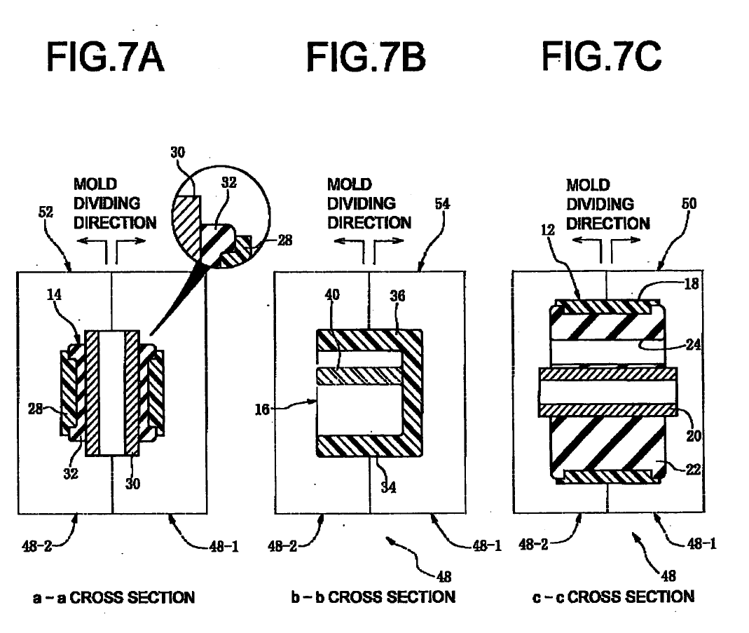

At this point in time, the resin mold 48 is divided in the axial direction relative to the first bushing 12 and in the axial perpendicular direction relative to the second bushing 14, but in this embodiment the resin mold 48 can be divided in the axial perpendicular direction without hindering the second bushing 14. FIG. 7 illustrates this in detail. As illustrated in FIG. 7A, in this embodiment, the rubber elastic body 32 of the second bushing 14 is longer in the axial direction than the outer casing 28. Because the entire outer surface in the axial direction of the rubber elastic body 32 is located beyond the axial end surfaces of the outer casing 28, the resin mold 48, specifically, the mold part 52 forming the second bushing 14, can be split, that is, divided, without interference in the axis-perpendicular direction of the second bushing 14.

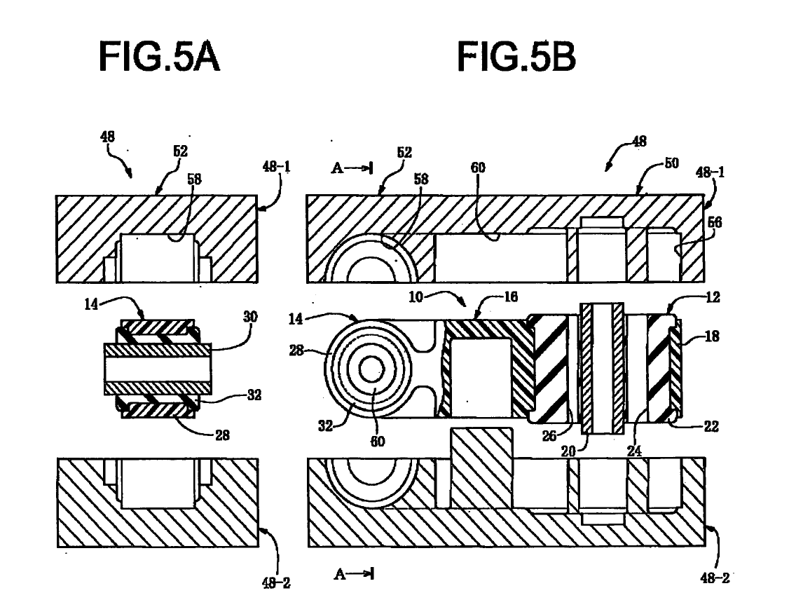

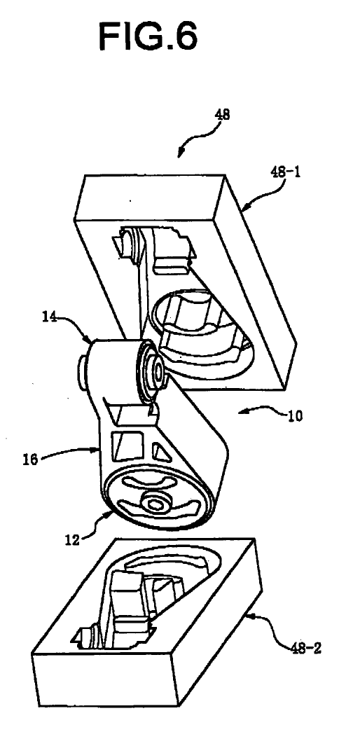

In this embodiment, because the connecting component 16 has a U-shaped cross section open in the same direction as the axial direction of the first bushing 12 (U-shape except for the rib 40 in FIG. 7B), the mold part 54 for the connecting component 16 can also be split, that is, divided, without interference in the axis-perpendicular direction of the first bushing 12, as illustrated in FIG. 7E. Naturally, the mold part 50 for the first bushing 12 can also be split, that is, divided, in the axis-perpendicular direction of the first bushing 12, as illustrated in FIG. 7C. The resin mold 48 in its entirety can thus be divided without interference in the axial direction of the first bushing 12, as illustrated in FIGS. 5 and 6.

As will be apparent from the above description, in this embodiment, the mold part 52 for the second bushing 14 and the mold part 54 for the connecting component 16 in the resin mold 48 can both be divided in the axial direction, that is, the same direction as the direction in which the mold part 50 for the first bushing 12 is divided.

It is thus possible to simplify the structure of the resin mold 48, reduce the costs of the resin mold 48, increase the number of resin torque rod 10 products that can be obtained per resin mold 48, and lower the resin torque rod 10 manufacturing costs,

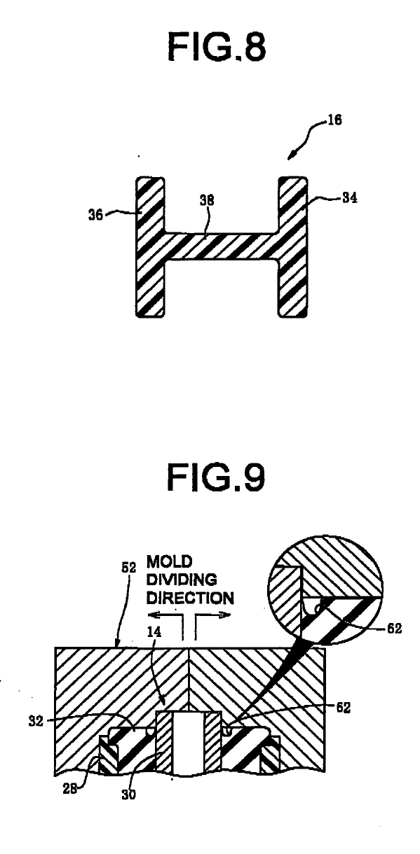

In the above embodiment, the connecting component 16 had a cross-shaped cross section, but it may also have an H-shaped cross section as illustrated in FIG. 8. In this case as well, the mold part 54 for the connecting component 16 in the resin mold 48 can be divided in the same direction as the mold part 50 for the first bushing 12.

In some cases, as illustrated in FIG. 9, a shallow ring-shaped depressions 62 can be provided on the axial end face on the inner peripheral side of the inner casing 30 and the rubber elastic body 32 of the second bushing 14. When such a recess 62 is shallow and is on the inner peripheral side of the inner casing 30, the shape of the cavity 58 can be prevented from becoming deformed by the flexing action of the rubber elastic body 32 at the injection pressure prevailing when the resin material is injected into the cavity 58. The outer casing 28 in the second bushing 14 can thus be molded with resin without interference, and the mold part 52 for the second bushing 14 can then be divided in the axis-perpendicular direction.

The connecting component 16 may be provided with a through hole or holes each extending therethrough in the mold dividing direction as needed.

While the presently preferred embodiments have been described in detail by way of example, the invention may be embodied with a variety of other modifications without departing from the spirit of the invention, such as the ability to make the axial outer surfaces of the rubber elastic body 32 of the second bushing 14 the same as the end surfaces of the outer casing 29.

It is also to be understood that the present invention may be embodied with various other changes, modifications and improvements, which may occur to those skilled in the art, without deputing from the spirit and scope of the invention defined in the following claims.

1. A resin torque rod comprising:
a first and second bushing disposed at both ends of the resin torque rod, each bushing having a resin outer casing and a rigid inner casing and a rubber elastic body interposed between the outer and inner casings, and
a resin connecting component for connecting the first and second bushings, the first and second bushings facing each other at right angles,
wherein the rubber elastic body in the second bushing is shaped such that at least outer peripheral portions of axial end faces of the rubber elastic body protrude the same as, or beyond axially outwardly from axial end faces of the resin outer easing of the second bushing, respectively, and that the intermediate portion in an axis-perpendicular direction between the inner casing and outer casing has a substantially solid shape, without any recesses open in the axial end faces thereof and extending axially inward from the axial end faces of the outer casing.

2. A resin torque rod according to claim 1, wherein the rubber elastic body of the first bushing is provided with voids extending axially inward from the axial and faces of the outer casing in the first bushing.

3. A resin torque rod according to claim 2, wherein the voids in the first bushing pass through the rubber elastic body in the axial direction.

4. A resin torque rod according to claim 1, wherein the first bushing has a greater diameter than the second bushing, and the second bushing is smaller than the first bushing.

5. A resin torque rod according to claim 1, wherein the connecting component comprises a pair of mutually facing side panels that extend in a direction linking the first and second bushings, and a connecting portion connecting the side panels, the pair of side panels and connecting portion having a U- or H-shaped lateral cross section open in a same direction as an axial direction of the first bushing.

6. A resin torque rod according to claim 5, wherein a reinforcing rib extending from a first bushing side to a second bushing side is provided in a space on an inside between the pair of side panels of the connecting component.

7. A resin torque rod according to claim 1, wherein the rubber elastic body of the second bushing is provided with a shallow annular depression open in the axial end face at an inner peripheral portion thereof.

8. A method of manufacturing a resin torque rod including: a first and second bushing disposed at both ends of the resin torque rod, each bushing having a resin outer casing and a rigid inner casing and a rubber elastic body interposed between the outer and inner casings; and a resin connecting component for connecting the first and second bushings, the first and second bushings facing each other at right angles, wherein the rubber elastic body in the second bushing is shaped such that at least outer peripheral portions of axial end faces of the rubber elastic body protrude the same as, or beyond axially outwardly from axial end faces of the resin outer casing of the second bushing, respectively, a that the intermediate portion in an axis-perpendicular direction between the inner casing and outer casing has a substantially solid shape, without any recesses open in the axial and faces thereof and extending axially inward from the axial end faces of the outer casing, the method comprising the steps of:
preparing first and second preliminary assemblies for the first and second bushings, each being formed by molding and bonding the rubber elastic body onto the rigid inner casing;
setting up the first and second preliminary assemblies in a mold having a first cavity part with a shape corresponding the outer casing of the first bushings a second cavity part with a shape corresponding the outer casing of the second bushing, and a third cavity part with a shape corresponding to the connecting component, such that an axis of the first preliminary assembly extends along with a mold dividing direction, while axis of the second preliminary assembly extend perpendicular to the mold dividing direction;
injecting a resin material into the cavity parts to integrally form the outer casings of the first and second bushings and connecting component with the first and second preliminary assemblies; and
dividing the mold into mold parts in the mold dividing direction along with an axial direction of the preliminary assembly of the first bushing to taken out a molded product from the mold.
